(19) United States
(12) Patent Application Publication
(10) Pub. No.: US 2014/0240183 A1
(43) Pub. Date: Aug. 28, 2014

(54) ELECTRONIC DEVICE WITH KEYBOARD

(71) Applicant: HON HAI PRECISION INDUSTRY CO., LTD., New Taipei (TW)

(72) Inventors: CHIA-MING CHANG, New Taipei (TW); YI-CHENG KUO, New Taipei (TW)

(73) Assignee: HON HAI PRECISION INDUSTRY CO., LTD., New Taipei (TW)

(21) Appl. No.: 14/139,976

(22) Filed: Dec. 24, 2013

(30) Foreign Application Priority Data
Feb. 26, 2013 (TW) 102106618

(51) Int. Cl. H01Q 1/22

(52) U.S. Cl. CPC H01Q 1/2258; H01Q 1/2275
USPC 343/720

(57) ABSTRACT

An electronic device includes circuit board and a keyboard. The keyboard includes a main body, a plurality of key caps, and an antenna module. The plurality of key caps is located on the main body. The antenna module is located on one of the plurality of key caps. The antenna module is configured to receive signals and sends the signals to the circuit board.

### BACKGROUND

1. Technical Field

The present disclosure relates to electronic devices, and more particularly to an electronic device with a keyboard.

2. Description of Related Art

A notebook always includes an antenna for receiving signals. The antenna is always secured to an outside surface of a keyboard of the notebook, which may affect the appearance of the notebook. Additionally, the antenna located on the outside surface is easily damaged when the notebook is used. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of an electronic device according to a first embodiment.

FIG. 2 is an assembled view of the electronic device of FIG. 1.

FIG. 3 is a cross-sectional view of the electronic device of FIG. 2 taken along line III-III.

FIG. 4 is an exploded view of an electronic device according to a second embodiment.

FIG. 5 is an assembled view of the electronic device of FIG. 4.

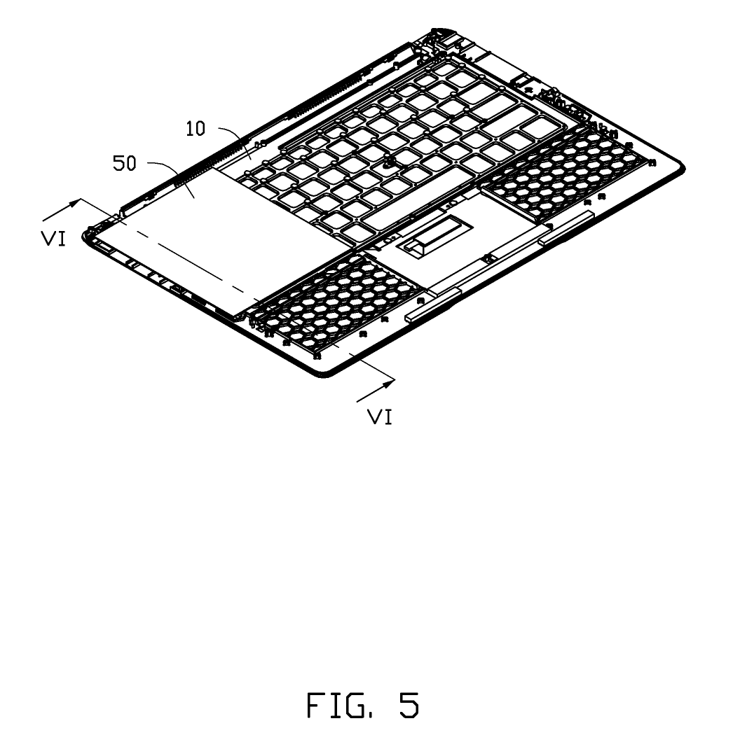

FIG. 6 is a cross-sectional view of the electronic device of FIG. 5 taken along line VI-VI.

### DETAILED DESCRIPTION

The disclosure is illustrated by way of example and not by way of limitation. In the figures of the accompanying drawings in which like references indicate similar elements. It should be noted that references to “an” or “one” embodiment in this disclosure are not necessarily to the same embodiment, and such references mean at least one.

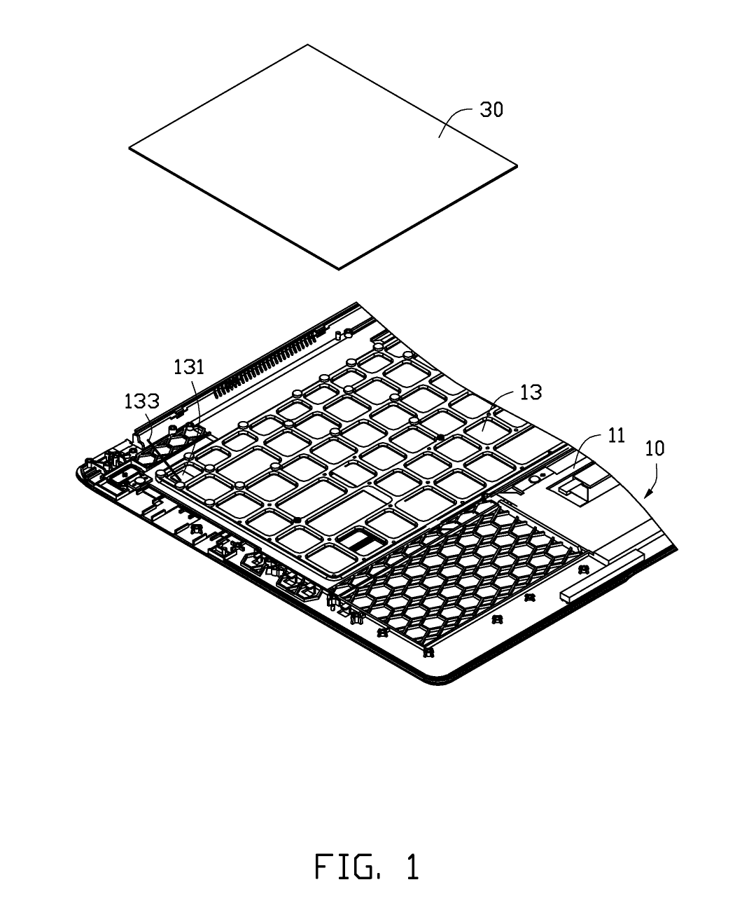

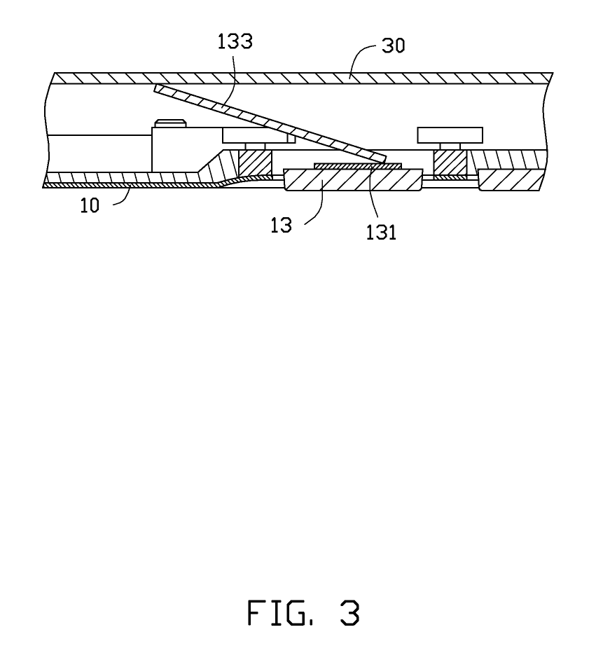

FIGS. 1 and 3 show a first embodiment of an electronic device. The electronic device includes a keyboard 10 and a circuit board 30 attached to the keyboard 10. In one embodiment, the circuit board 30 is network card, and the electronic device may be a notebook computer.

The keyboard 10 includes a main body 11 and a plurality of key caps 13 located on the main body 11. An antenna module 131 is attached on one of the plurality of key caps 13. A first end of a data cable 133 is connected to the antenna module 131. In one embodiment, the data cable 133 is soldered on the antenna module 131. One of the plurality of key caps 13 is adjacent to a right side edge or left side edge of the main body 11, to prevent signals from being shielded when an end user uses the keyboard 10.

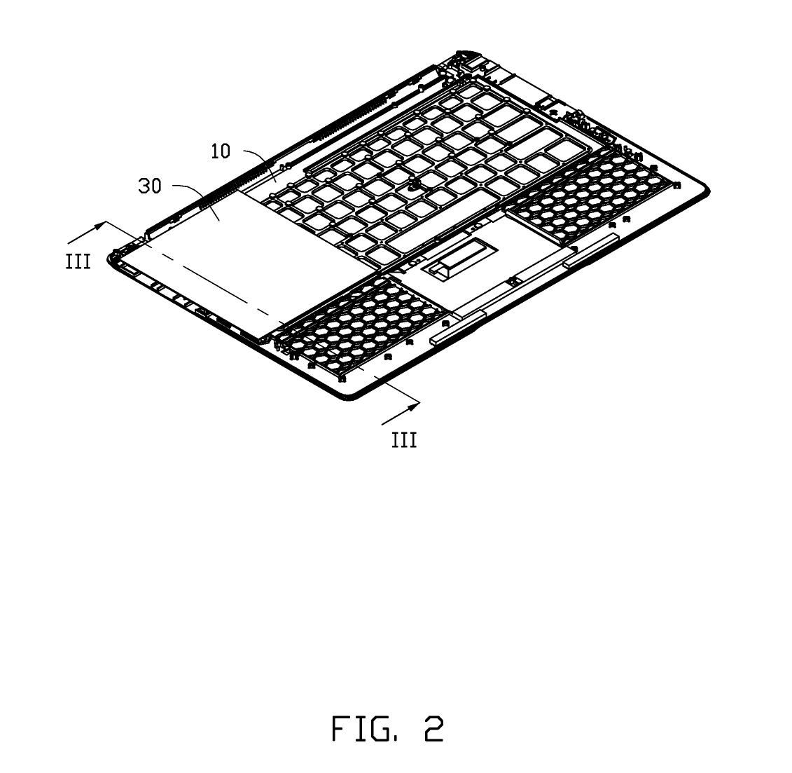

FIGS. 2 and 3 show that in assembly of the circuit board 30, the circuit board 30 is attached to the keyboard 10. A second end opposite to the first end of the data cable 133 is contacted with the circuit board 30. The antenna module 131 receives a signal and sends the signal to the circuit board 30 through the data cable 133. The circuit board 30 sends a signal to the antenna module 131 through the data cable 133, and the antenna module 131 sends the signals. Thus, the signals of the antenna module 131 cannot be shielded and cannot be damaged.

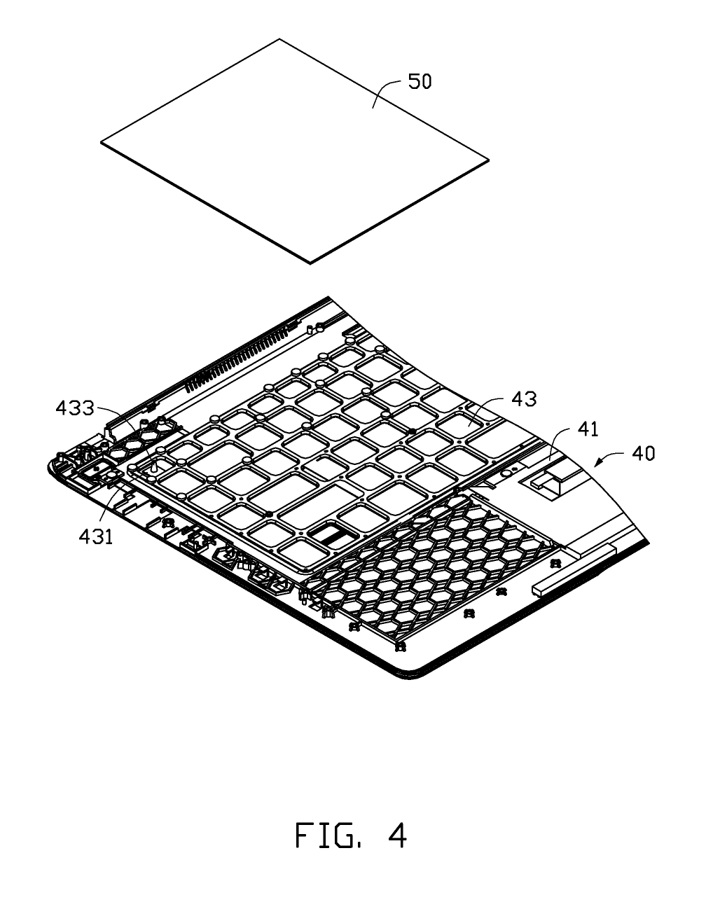

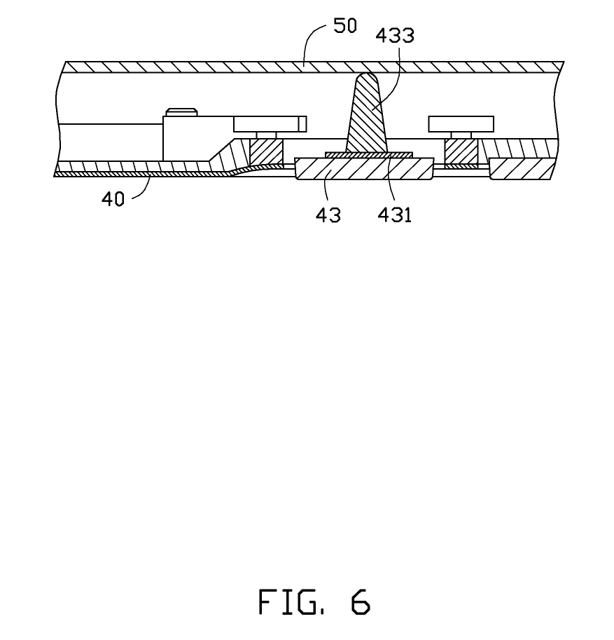

FIGS. 4 and 6 show that a second embodiment of an electronic device includes a keyboard 40 and a circuit board 50. The circuit board 50 is a main body integrated with a network card.

The keyboard 40 includes a main body 41 and a plurality of key caps 43 located on the main body 41. An antenna module 431 is located on and attached to one of the plurality of key caps 43. In one embodiment, the antenna module 431 is secured to the one of the plurality of key caps 43 by radium carved method. In another embodiment, the antenna module 431 is glued on the one of the plurality of key caps 43. A pin 433 is located on the antenna module 43. In one embodiment, the pin 433 can be resiliently deformable. The one of the plurality of key caps 43 is adjacent to a right side or left side of the keyboard 10.

FIGS. 2 and 3 show that in assembly of the circuit board 50, the circuit board 50 is attached to the keyboard 40. The pin 433 abuts the circuit board 50 to electrically connect the antenna module 431 to the circuit board 50. The antenna module 431 receives signals and sends the signals to the circuit board 50 via the pin 433. The circuit board 50 can send signals to the antenna module 431 via the pin 433, and the antenna module 431 sends the signals. The antenna module 431 cannot be shield and demanged, and on the other hand, the appearance of the keyboard 40 is not affected.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A keyboard comprising:
a main body;
a plurality of key caps located on the main body; and
an antenna module being located on one of the plurality of key caps,
wherein the antenna module is configured to receive signals and sends the signals to a circuit board.

2. The keyboard of claim 1, wherein the antenna module is glued on one of the plurality of key caps.

3. The keyboard of claim 1, further comprising a data cable, wherein the data cable is electrically connected to the antenna module and the circuit board.

4. The keyboard of claim 1, further comprising a pin, wherein the pin is located on the antenna module.

5. The keyboard of claim 4, wherein the pin is electrically connected to the circuit board.

6. The keyboard of claim 5, wherein the pin is resiliently deformable.

7. The keyboard of claim 1, wherein one of plurality of key caps is adjacent to a right side edge or a left side edge of keyboard.

8. An electronic device comprising:
a circuit board; and
a keyboard, the keyboard comprising:
a main body;
a plurality of key caps located on the main body; and
an antenna module being located on one of the plurality of key caps,
wherein the antenna module is configured to receive signals and sends the signals to the circuit board.

9. The electronic device of claim 8, wherein the circuit board is network card.

10. The electronic device of claim 8, wherein the circuit board is main body integrated with a network card.

11. The electronic device of claim 8, wherein the antenna module is glued on one of the plurality of key caps.

12. The electronic device of claim 8, further comprising a data cable, wherein the data cable is electrically connected to the antenna module and the circuit board.

13. The electronic device of claim 8, further comprising a pin, wherein the pin is located on the antenna module.

14. The electronic device of claim 13, wherein the pin is electrically connected to the circuit board.

15. The electronic device of claim 13, wherein the pin is resiliently deformable.

16. The electronic device of claim 8, wherein one of plurality of key caps is adjacent to a right side edge or left side edge of keyboard.
